(19) United States
(12) Patent Application Publication
(10) Pub. No.: US 2017/0279209 A1
(43) Pub. Date: Sep. 28, 2017

(54) ELECTRONIC APPARATUS

(71) Applicant: CANON KABUSHIKI KAISHA, Tokyo (JP)

(72) Inventor: Keisuke Kitajima, Nagareyama-shi (JP)

(21) Appl. No.: 15/455,581

(22) Filed: Mar. 10, 2017

(30) Foreign Application Priority Data
Mar. 24, 2016 (JP) 2016-060898

(51) Int. Cl. H01R 12/71; H01R 24/28; H01R 12/75; H01R 24/64

(52) U.S. Cl. CPC H01R 12/716; H01R 24/64; H01R 24/28; H01R 12/75; H01R 2107/00

(57) ABSTRACT

An electronic apparatus including: a circuit board; plurality of connectors that are arranged on the circuit board with a predetermined interval therebetween, are orientated in opposite directions from each other, and have a same shape; and a plurality of cables that respectively have connectors that are orientated in opposite directions from each other relative to a direction in which cords thereof extend, the connectors being configured to be respectively connected to the plurality of connectors. Out of the plurality of cables, a first cable that is configured to be connected to a first connector out of the plurality of connectors has a length that is determined such that the first cable is not connectable to a second connector out of the plurality of connectors.

### BACKGROUND OF THE INVENTION

Field of the Invention

The present invention relates to an electronic apparatus.

Description of the Related Art

In some cases, in order to realize, for example, a printing function and a storage function, an electronic apparatus connects to dedicated devices that have such functions, via a general-purpose interface such as USB. In such cases, in order to realize a plurality of functions, the electronic apparatus is configured such that a plurality of general-purpose connectors are arranged on a control board of the electronic apparatus, and the devices are connected to the electronic apparatus via cables from the connectors. As examples of such interface cables, standardized cables such as USB (Universal Serial Bus) cables and SATA (serial ATA) cables, which conform to the general-purpose interface, are used in order to realize excellent transmission properties at low cost. For example, in a case where the functionality is expanded by using a USB interface, the electronic apparatus is configured such that a USB controller that has a plurality of USB host functions and a plurality of USB connectors are arranged on a circuit board of the electronic apparatus, and the electronic apparatus is connected to expansion boards that correspond to the functions via USB cables.

However, if a plurality of general-purpose connectors and cables are used in this way, there is the possibility of a cable being connected to a wrong connector. If such improper connection occurs, the functionality and the properties provided by the manufacture cannot be achieved. Therefore, there is a proposal of a structure that prevents interface cables from improperly installed. For example, Japanese Patent Laid-Open No. 2001-15223 proposes, as a mechanism for preventing improper installation of wiring within the apparatus, a technique for preventing cables from being connected to wrong connectors by varying the number of poles and the shape of the terminal for each connector.

However, according to the technique disclosed in Japanese Patent Laid-Open No. 2001-15223, it is necessary to vary the number of poles and the shape of the terminal for each connector, and therefore this technique cannot be employed in a case where connectors that conform to a particular standard and have the same shape, such as USB connectors, are to be arranged.

### SUMMARY OF THE INVENTION

An aspect of the present invention is to eliminate the above-mentioned problems with the conventional techniques.

A feature of the present invention is to provide a technique for preventing connectors and cables from being improperly connected, even in a case where a plurality of connectors that have the same shape are arranged.

According to a first aspect of the present invention, there is provided an electronic apparatus comprising: a circuit board; a plurality of connectors that are arranged on the circuit board with a predetermined interval therebetween, are orientated in opposite directions from each other, and have a same shape; and a plurality of cables that respectively have connectors that are orientated in opposite directions from each other relative to a direction in which cords thereof extend, the connectors being configured to be respectively connected to the plurality of connectors, wherein, out of the plurality of cables, a first cable that is configured to be connected to a first connector out of the plurality of connectors has a length that is determined such that the first cable is not connectable to a second connector out of the plurality of connectors.

According to a second aspect of the present invention, there is provided an electronic apparatus comprising: a circuit board; a plurality of USB connectors that are arranged on the circuit board, are orientated in opposite directions from each other, and have a same shape; and a plurality of USB cables that respectively have USB connectors, and are configured to be respectively connected to the plurality of USB connectors, wherein the respective USB connectors of the plurality of USB cables are orientated in opposite directions from each other.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram for describing an example of connections between control boards in an electronic apparatus according to an embodiment of the present invention.

FIG. 2 is a diagram showing an example of an arrangement of connectors of a control board according to the embodiment.

FIG. 3 is diagram showing a cable and a connector that are to be connected to a USB connector of the control board according to the embodiment.

FIG. 4 is diagram showing a cable and a connector that are to be connected to a USB connector of the control board according to the embodiment.

FIG. 5 is a diagram showing a situation in which the cables are connected to the control board according to the embodiment, viewed from the top side of the sheet of FIG. 2.

FIG. 6 is a diagram showing a plurality of USB cables that are connected to the control board of the electronic apparatus according to the embodiment.

FIG. 7 is a diagram showing an example in which a cable is mistakenly connected to a connector of the control board in the electronic apparatus according to the embodiment.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

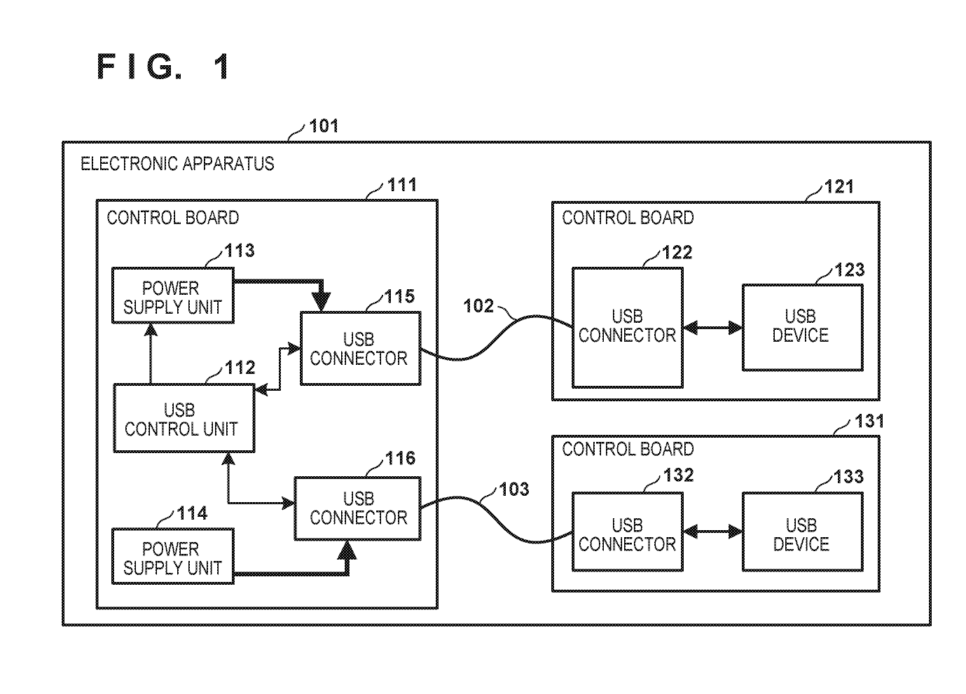

FIG. 1 is a diagram for describing an example of connections between control boards in an electronic apparatus 101 according to an embodiment of the present invention.

The electronic apparatus 101 includes a control board 111, a control board 121, and a control board 131. The control board 111 and the control board 121 are connected to each other via a cable 102. Also, the control board 111 and the control board 131 are connected to each other via a cable 103. In the present embodiment, mini-B type USB (Universal Serial Bus) cables are used as the cables 102 and 103.

The control board 111 has a USB controller 112, a power supply unit 113, a power supply unit 114, and USB connectors 115 and 116. The USB controller 112 is a control IC that can operate as a USB host. The USB controller 112 has at least two USB interface functions, and is connected to the USB connectors 115 and 116 on the control board 111. The power supply unit 113 and the power supply unit 114 are respectively connected to the USB connector 115 and the USB connector 116 as USB power supplies, and are used as a driving power supply for the control board 121 and a driving power supply for the control board 131. Mini-B type USB connectors are used as the USB connectors 115 and 116. The USB connector 115 and the USB connector 116 are respectively connected to the cable 102 and the cable 103.

The control board 121 has a USB connector 122 and a USB device 123. The control board 131 has a USB connector 132 and a USB device 133.

In the present embodiment, mini-B type USB connectors are used as the USB connectors 122 and 132. Each of the USB devices 123 and 133 is a USB device that can be connected to, for example, a USB interface, and that has, for example, a Wi-Fi function or a Bluetooth® function. In this way, it is possible to provide the electronic apparatus 101 with a Wi-Fi function and a Bluetooth function by connecting the USB devices 123 and 133 thereto.

The USB controller 112 is also connected to the power supply unit 113, and controls power supply to the control board 121. With this configuration, if, for example, the electronic apparatus 101 is set so as to disable the function of the control board 121, the USB controller 112 can stop power supply from the power supply unit 113 to the control board 121. In contrast, the power supply unit 114 constantly supplies power to the USB connector 116. Therefore, although the USB connectors 115 and 116 have the same shape, different functions can be connected to the USB connectors 115 and 116, respectively.

Note that the functions of the USB devices are not limited to the above-described examples. For example, a device that can provide a storage function, a display function, a printing function, or the like may be employed.

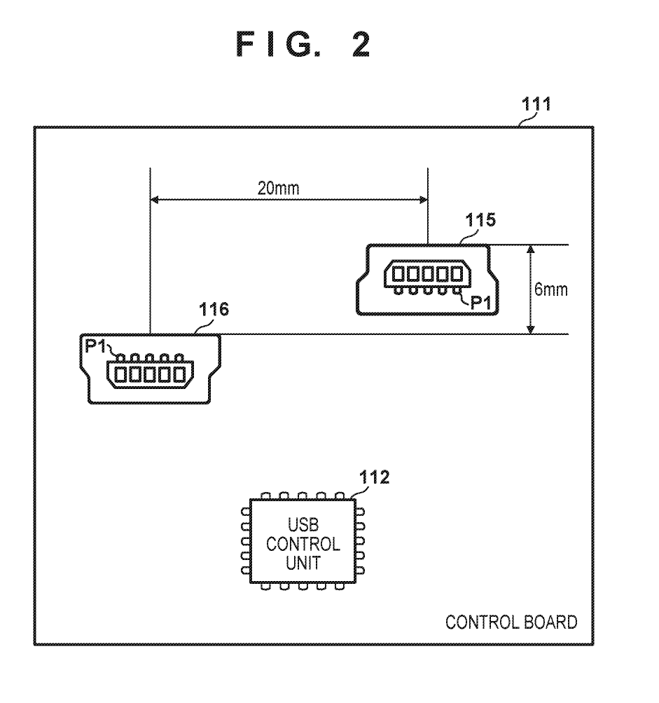

FIG. 2 is a diagram showing an example of an arrangement of the connectors of the control board 111 according to the embodiment. In FIG. 2, components that are the same as those shown in FIG. 1 are denoted by the same reference numerals.

On this control board 111, as shown in FIG. 2, the USB connectors 115 and 116 that are to be connected to the USB controller 112 have the same shape, and are arranged such that their orientations are different from each other by 180 degrees (so as to be orientated in opposite directions), and a predetermined interval is provided therebetween. In the present embodiment, the USB connectors 115 and 116 are arranged on the control board 111 with an interval of 6 mm in the vertical direction and an interval of 20 mm in the horizontal direction. Note that, in FIG. 2, each of the terminals denoted by “P1” is the first pin. Upon the cables 102 and 103 described below being installed, the terminals denoted by “P1” are respectively connected to the P1 terminals of the connectors of these cables.

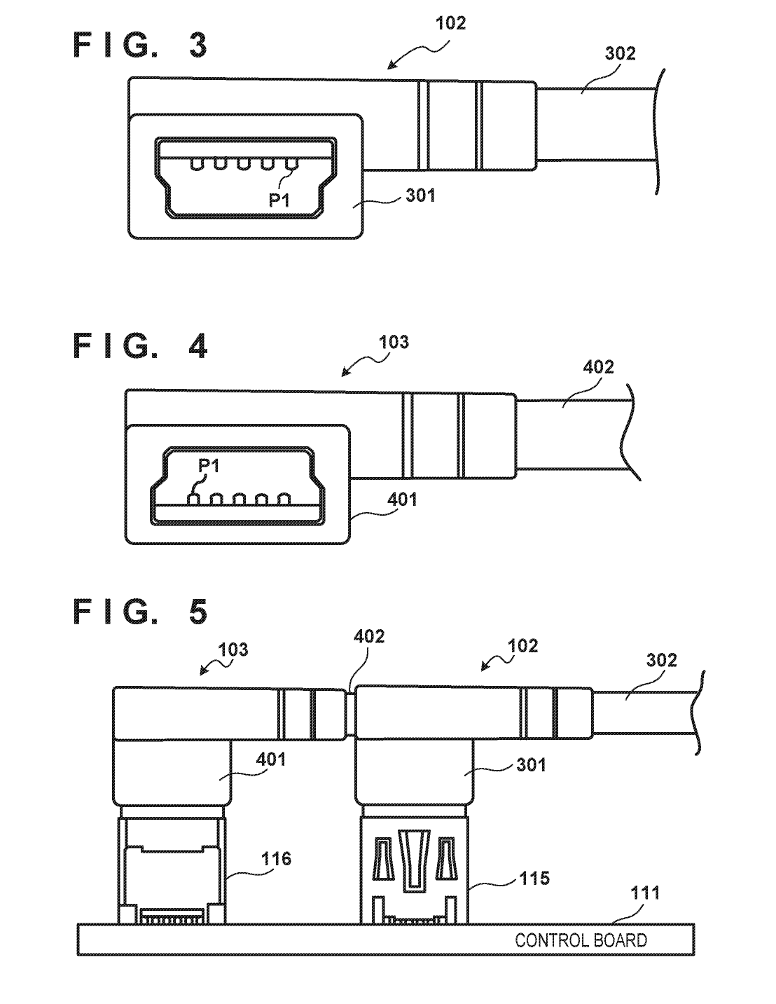

FIG. 3 is a diagram illustrating the L-shaped connector cable 102 and a connector 301 that are to be connected to the USB connector 115 of the control board 111 according to the present embodiment.

The cable 102 has the L-shaped connector 301, and this connector 301 is to be connected to the USB connector 115 of the control board 111 shown in FIG. 2. Here, the cable 102 and the connector 301 are connected to the USB connector 115 shown in FIG. 2 such that the connector 301 in the state shown in FIG. 3 is rotated to face the back side of the sheet of FIG. 3. Thus, a cord 302 of the cable 102 is shaped so as to extend toward the side on which the P1 terminal is present (the right side in FIG. 2).

FIG. 4 is a diagram showing the cable 103 and a connector 401 that are to be connected to the USB connector 116 of the control board 111 according to the present embodiment. As can be seen from a comparison with the cable 102 shown in FIG. 3, the direction in which the terminals of the connector 401 of the cable 103 are arranged, relative to the direction in which a cord 402 extends, is opposite to the direction in which the terminals of the connector 301 shown in FIG. 3 are arranged.

The cable 103 has the L-shaped connector 401, and is to be connected to the USB connector 116 of the control board 111 shown in FIG. 2. Here, the cable 103 and the connector 401 are connected to the USB connector 116 shown in FIG. 2 such that the connector 401 in the state shown in FIG. 4 is rotated to face the back side of the sheet of FIG. 4. Thus, the cord 402 of the cable 103 is shaped so as to extend toward the side that is opposite the side on which the P1 terminal is present (so as to extend toward the right side in FIG. 2).

Therefore, both the cables 102 and 103 connected to the control board 111 are installed so as to extend toward the right side of the control board 111 shown in FIG. 2.

FIG. 5 is a diagram showing a situation in which the cables 102 and 103 are connected to the control board 111 according to the embodiment, viewed from the top side of the sheet of FIG. 2.

As described above, the USB connectors 115 and 116 are arranged by rotating them by 180 degrees from each other. Since the cables 102 and 103 are configured as shown in FIGS. 3 and 4, the respective cords 302 and 402 of the cables 102 and 103 are drawn out in the same direction, relative to the control board 111, as shown in FIG. 5.

FIG. 6 is a diagram showing a plurality of USB cables that are connected to the control board 111 of the electronic apparatus 101 according to the present embodiment. Note that, in FIG. 6, components that are the same as those shown in the above-described drawings are denoted by the same reference numerals.

The control board 111 is installed to the electronic apparatus 101 by using a supporting metal plate 104. As indicated by the dotted line, the supporting metal plate 104 is provided with a hole 601, and is thus configured to allow the cords 302 and 402 of the cables 102 and 103 to pass therethrough.

The cable 102 and the cable 103 respectively connected to the USB connector 115 and the USB connector 116 of the control board 111 pass through the hole 601 of the above-described supporting metal plate 104, and are respectively connected to the control board 121 and the control board 131. In FIG. 6, the cable 102 is connected to the USB connector 122 of the control board 121.

Note that the cable 102 is manufactured such that manufacturing variations in the total length thereof are within the range of ±10 mm. In the case where the manufacturing size is at the minimum, the cable 102 needs to be connected along the path between the USB connector 115 of the control board 111 and the USB connector 122 of the control board 121. Therefore, the cable 102 is designed so as to have an extra length of 20 mm at maximum.

If a user mistakenly attempts to connect the cable 102 to the USB connector 116, as can be seen from FIG. 2, the user needs to rotate the connector 301 of the cable 102 by 180 degrees.

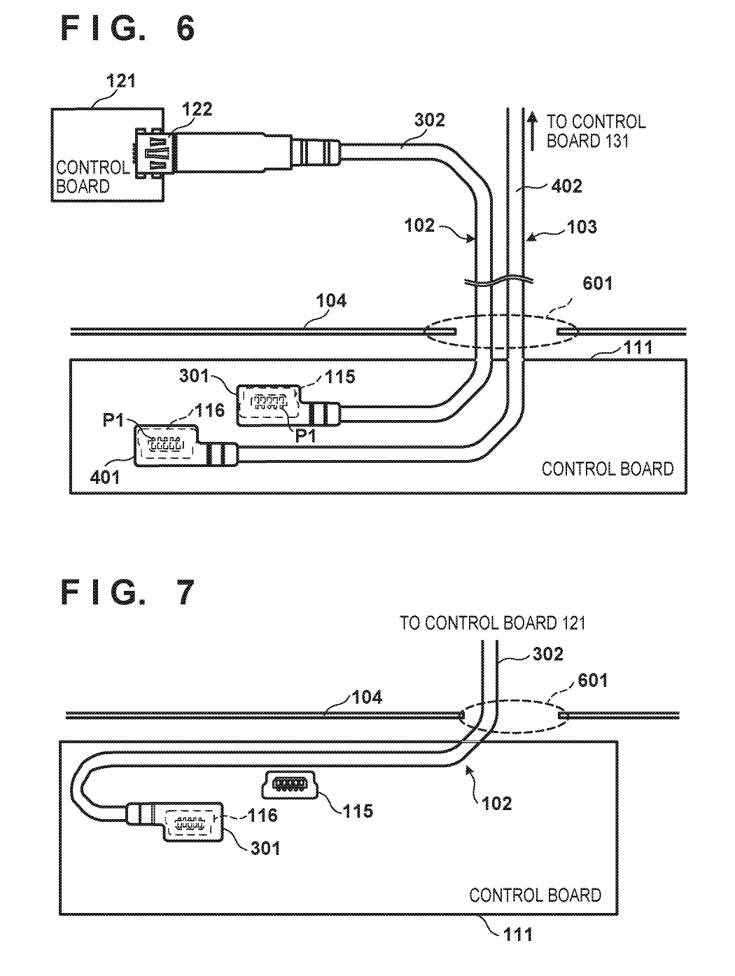

FIG. 7 is a diagram showing an example in which the cable 102 is mistakenly connected to the connector 116 of the control board 111 in the electronic apparatus 101 according to the present embodiment. Note that, in FIG. 7, components that are the same as those in the above-described drawings are denoted by the same reference numerals.

Here, the cable 102 has a length that matches the length of the path between the USB connector 115 of the control board 111 and the USB connector 122 of the control board 121. Therefore, unlike the case shown in FIG. 7, the cable 102 does not have a sufficient extra length that allows the connector 301 to be rotated and connected to the USB connector 116. Specifically, as described above, manufacturing variations in the length of the cable 102 are within the range of ±10 mm, and the extra length is 20 mm at maximum. Here, as shown in FIG. 2, the interval between the USB connectors 115 and 116 of the control board 111 is 20 mm. Therefore, unlike the case shown in FIG. 7, it is impossible to connect the USB connector 116 of the control board 111 and the control board 121 by using the cable 102.

Thus, it is possible to prevent the cable 102 from being mistakenly connected to the USB connector 116.

Note that similar setting can be applied to the cable 103 as well.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-060898, filed Mar. 24 2016, which is hereby incorporated by reference herein in its entirety.

What is claimed is:

1. An electronic apparatus comprising:
a circuit board;
a plurality of connectors that are arranged on the circuit board with a predetermined interval therebetween, are orientated in opposite directions from each other, and have a same shape; and
a plurality of cables that respectively have connectors that are orientated in opposite directions from each other relative to a direction in which cords thereof extend, the connectors being configured to be respectively connected to the plurality of connectors,
wherein, out of the plurality of cables, a first cable that is configured to be connected to a first connector out of the plurality of connectors has a length that is determined such that the first cable is not connectable to a second connector out of the plurality of connectors.

2. The electronic apparatus according to claim 1,
wherein the plurality of connectors include a USB connector.

3. The electronic apparatus according to claim 2,
wherein the plurality of cables include a USB cable.

4. The electronic apparatus according to claim 1,
where a connector of the first cable that is configured to be connected to the first connector is an L-shaped connector.

5. The electronic apparatus according to claim 1,
wherein the first cable is a USB cable that is configured to be connected to a USB device that has a Wi-Fi function or a Bluetooth function.

6. The electronic apparatus according to claim 1,
wherein when the plurality of cables are respectively connected to the plurality of connectors on the circuit board in one-to-one correspondence, the cords of the plurality of cables extend in a same direction from the circuit board.

7. An electronic apparatus comprising:
a circuit board;
a plurality of USB connectors that are arranged on the circuit board, are orientated in opposite directions from each other, and have a same shape; and
a plurality of USB cables that respectively have USB connectors, and are configured to be respectively connected to the plurality of USB connectors,
wherein the respective USB connectors of the plurality of USB cables are orientated in opposite directions from each other.

8. The electronic apparatus according to claim 7,
wherein, out of the plurality of USB cables, a first cable that is configured to be connected to a first connector out of the plurality of USB connectors arranged on the circuit board has a length that is determined such that the first cable is not connectable to a second connector out of the plurality of USB connectors.

9. The electronic apparatus according to claim 7,
wherein the connectors of the plurality of USB cables are L-shaped connectors.
